(19) United States
(12) Patent Application Publication
(10) Pub. No.: US 2016/0335403 A1
(43) Pub. Date: Nov. 17, 2016

(54) A CONTEXT SENSITIVE MEDICAL DATA ENTRY SYSTEM

(71) Applicant: KONINKLIJKE PHILIPS N.V., Eindhoven (NL)

(72) Inventors: THUSITHA DANANJAYA DE SI MABOTUWANA, BETHEL, WA (US); MERLIJN SEVENSTER, CHICAGO, IL (US); YUECHEN QIAN, LEXINGTON, MA (US)

(73) Assignee: Koninklijke Philips N.V., Eindhoven (NL)

(21) Appl. No.: 15/109,906

(22) PCT Filed: Jan. 19, 2015
(86) PCT No.: PCT/IB2015/050387

§ 371 Date: Jul. 6, 2016

Related U.S. Application Data
(60) Provisional application No. 61/933,455, filed on Jan. 30, 2014.

(51) Int. Cl. G06F 19/00; G06F 17/30

(52) U.S. Cl. CPC G06F 19/324; G06F 19/345; G06F 17/30684; G06F 17/30265

(57) ABSTRACT

A system for providing actionable annotations includes a clinical database storing one or more clinical documents including clinical data. A natural language processing engine which processes the clinical documents to detected clinical data. A context extraction and classification engine which generates clinical context information from the clinical data. An annotation recommending engine which generates a list of recommended annotations based on the clinical context information. A clinical interface engine which generates a user interface displaying the list of selectable recommended annotations.

The present application relates generally to providing context sensitive actionable annotations in a context-sensitive manner that requires minimal user interaction. It finds particular application in conjunction with determining a context sensitive list of annotations that enables the user to consume information related to the annotations and will be described with particular reference there. However, it is to be understood that it also finds application in other usage scenarios and is not necessarily limited to the aforementioned application.

The typical radiology workflow involves a physician first referring a patient to a radiology imaging facility to have some imaging performed. After the imaging study has been performed, using X-ray, CT, MRI (or some other modality), the images are transferred to a picture archiving and communication system (PACS) using Digital Imaging and Communications in Medicine (DICOM) standard. Radiologists read images stored in PACS and generate a radiology report using dedicated reporting software.

In the typical radiology reading workflow, the radiologist would go through an imaging study and annotate specific regions of interest, for instance, areas where calcifications or tumors can be observed on the image. The current image viewing tools (e.g., PACS) support the image annotation workflow primarily by providing a static list of annotations the radiologist can select from, sometimes grouped together by anatomy. The radiologist can select a suitable annotation (e.g., “calcification”) from this list, or alternatively, select a generic “text” tool and input the description related to the annotation as free-text (e.g., “Right heart border lesion”), for instance, by typing. This annotation will then be associated with the image, and a key-image can be created if needed.

This workflow has two drawbacks; firstly, selecting the most appropriate annotation from a long list is time-consuming, error-prone (e.g., misspelling) and does not promote standardized descriptions (e.g., liver mass vs. mass in the liver). Secondly, the annotation is simply attached to the image and is not actionable (e.g., a finding that needs to be followed-up can be annotated on the image, but this information cannot be readily consumed by a downstream user i.e., not actionable).

The present application provides a system and method which determines a context sensitive list of annotations that are also tracked in an “annotation tracker” enabling users to consume information related to annotations. The system and method supports easy navigation from annotations to images and provides an overview of actionable items, potentially improving workflow efficiency. The present application also provides new and improved methods and systems which overcome the above-referenced problems and others.

In accordance with one aspect, a system for providing actionable annotations is provided. The system includes a clinical database storing one or more clinical documents including clinical data. A natural language processing engine which processes the clinical documents to detected clinical data. A context extraction and classification engine which generates clinical context information from the clinical data. An annotation recommending engine which generates a list of recommended annotations based on the clinical context information. A clinical interface engine which generates a user interface displaying the list of selectable recommended annotations.

In accordance with another aspect, a system for providing recommended annotations is provided. The system includes one or more processors programmed to store one or more clinical documents including clinical data, process the clinical documents to detected clinical data, generate clinical context information from the clinical data, generate a list of recommended annotations based on the clinical context information, and generate a user interface displaying the list of selectable recommended annotations.

In accordance with another aspect, a method for providing recommended annotations is provided. The method includes storing one or more clinical documents including clinical data, processing the clinical documents to detected clinical data, generating clinical context information from the clinical data, generating a list of recommended annotations based on the clinical context information, and generating a user interface displaying the list of selectable recommended annotations.

One advantage resides in providing the user with a context sensitive, targeted list of annotations.

Another advantage resides in enabling the user to associate actionable events (e.g., “follow-up”, “tumor board meeting”) to annotations.

Another advantage resides in enabling a user to insert annotation related content directly into the final report.

Another advantage resides in providing a list of prior annotations that can be used for enhanced annotation-to-image navigation.

Another advantage resides in improved clinical workflow.

Another advantage resides in improved patient care.

Still further advantages of the present invention will be appreciated to those of ordinary skill in the art upon reading and understanding the following detailed description.

The invention may take form in various components and arrangements of components, and in various steps and arrangement of steps. The drawings are only for purposes of illustrating the preferred embodiments and are not to be construed as limiting the invention.

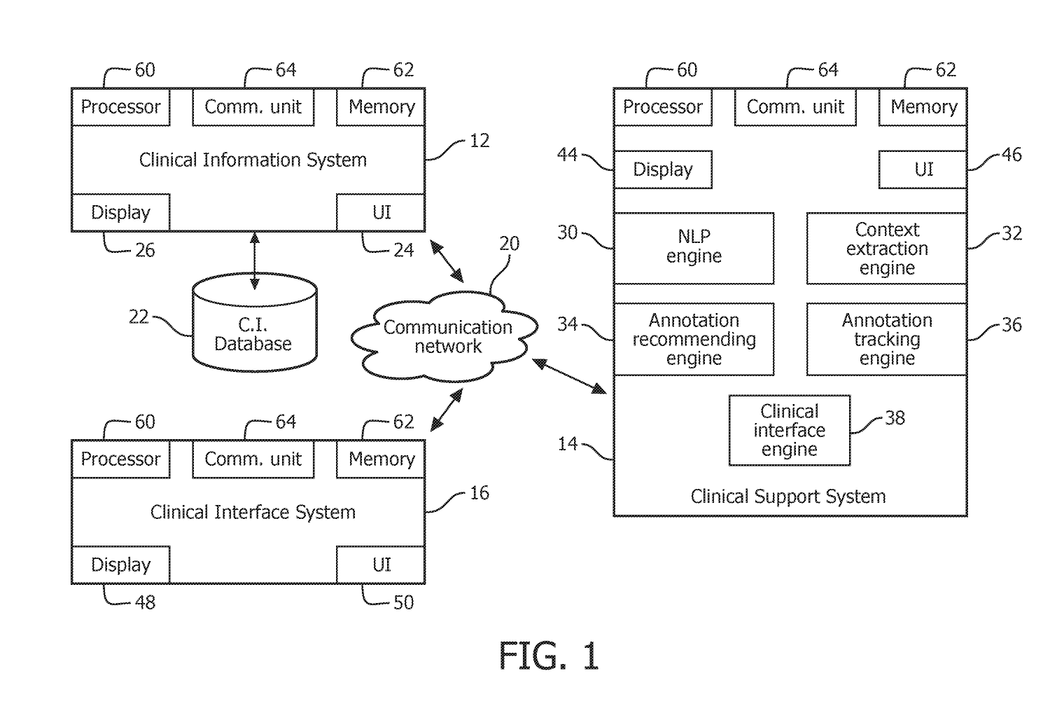

FIG. 1 illustrates a block diagram of an IT infrastructure of a medical institution according to aspects of the present application.

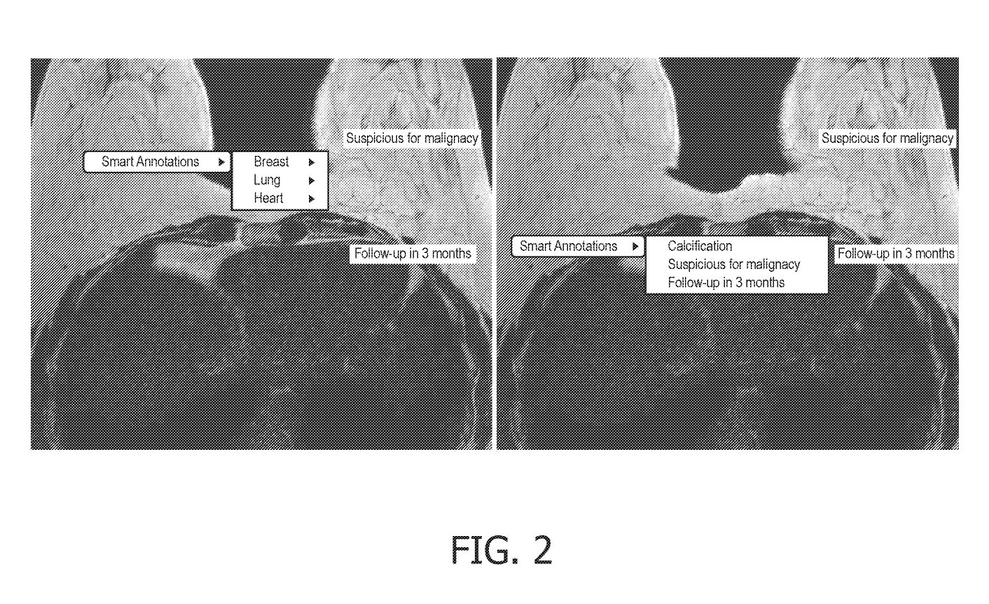

FIG. 2 illustrates an exemplary embodiment of clinical context interface generated by a clinical support system according to aspects of the present application.

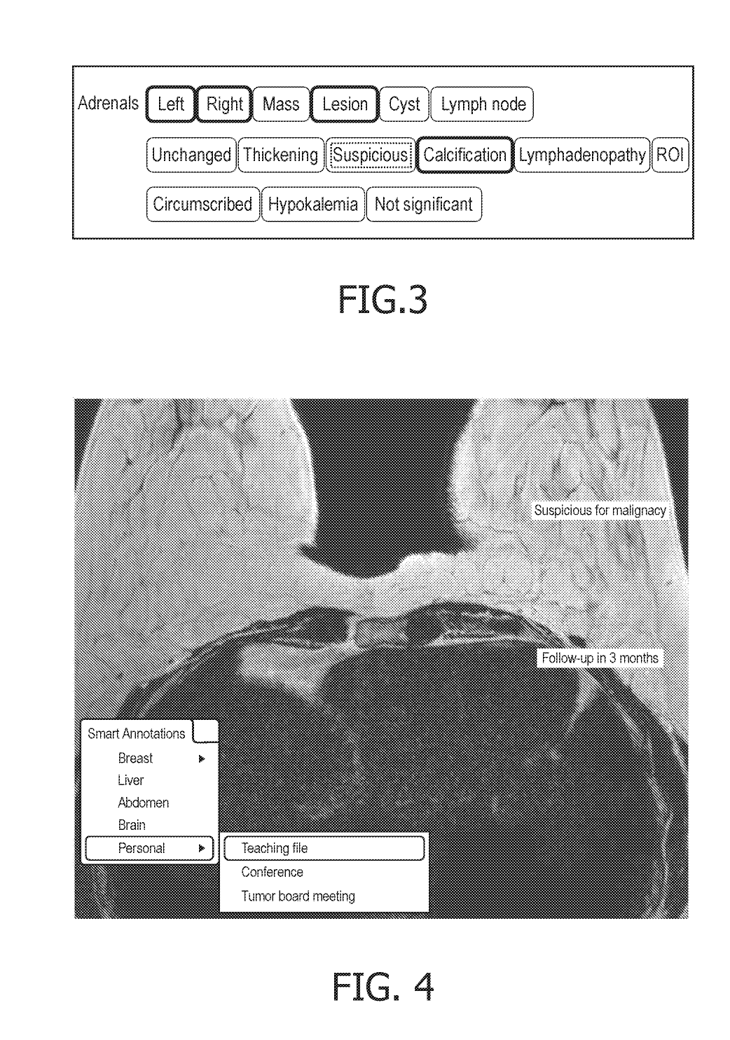

FIG. 3 illustrates another exemplary embodiment of clinical context interface generated by a clinical support system according to aspects of the present application.

FIG. 4 illustrates another exemplary embodiment of clinical context interface generated by a clinical support system according to aspects of the present application.

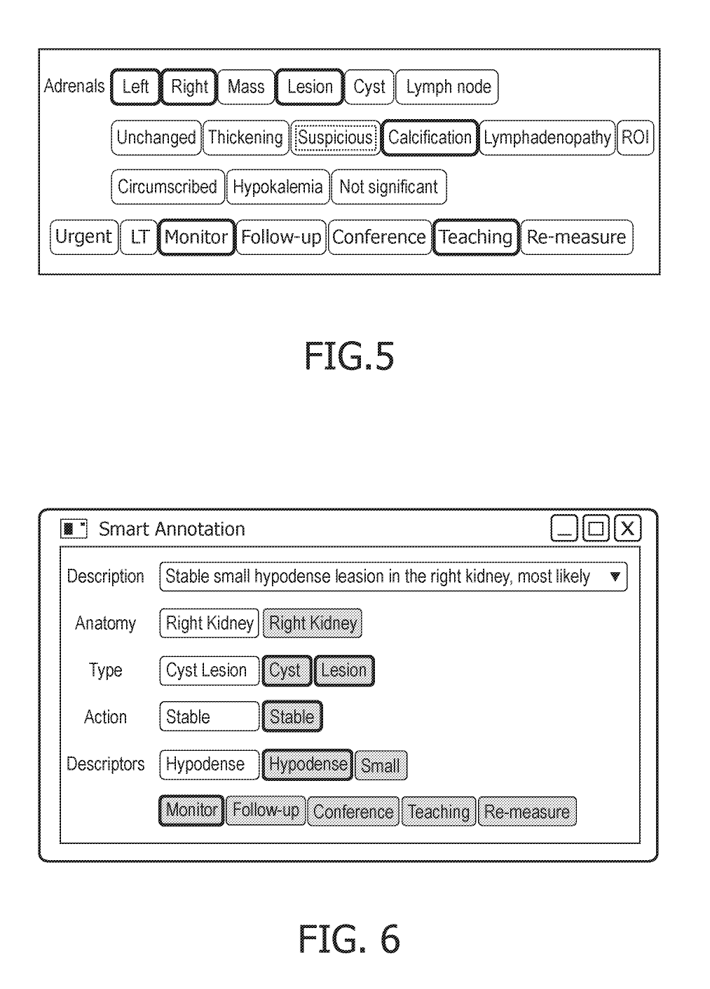

FIG. 5 illustrates another exemplary embodiment of clinical context interface generated by a clinical support system according to aspects of the present application.

FIG. 6 illustrates another exemplary embodiment of clinical context interface generated by a clinical support system according to aspects of the present application.

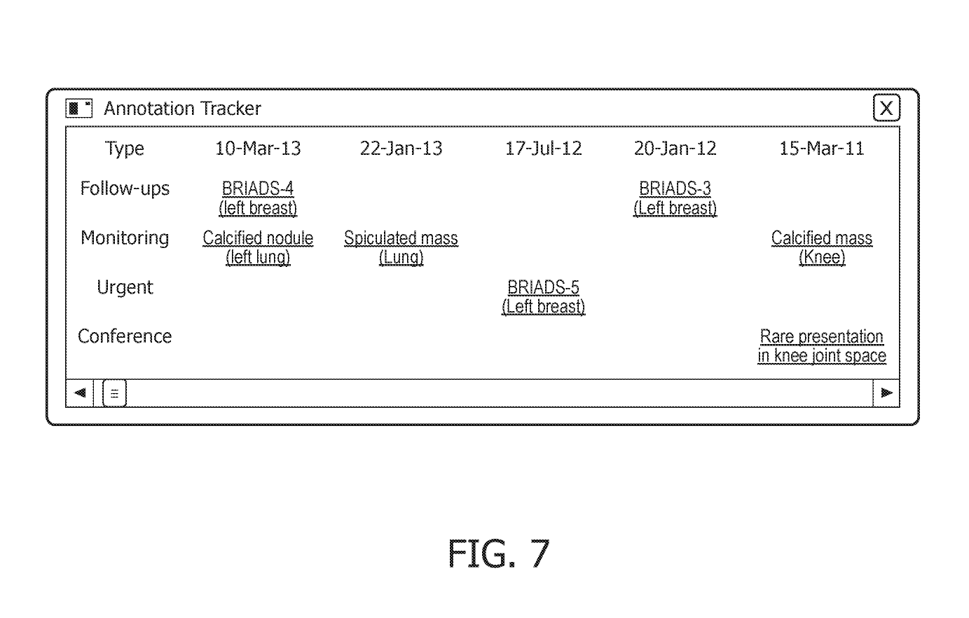

FIG. 7 illustrates another exemplary embodiment of clinical context interface generated by a clinical support system according to aspects of the present application.

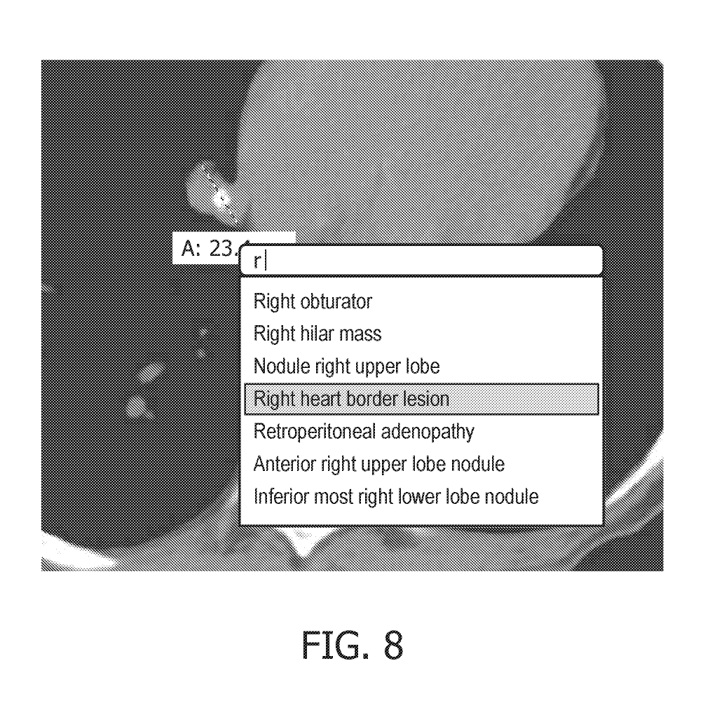

FIG. 8 illustrates another exemplary embodiment of clinical context interface generated by a clinical support system according to aspects of the present application.

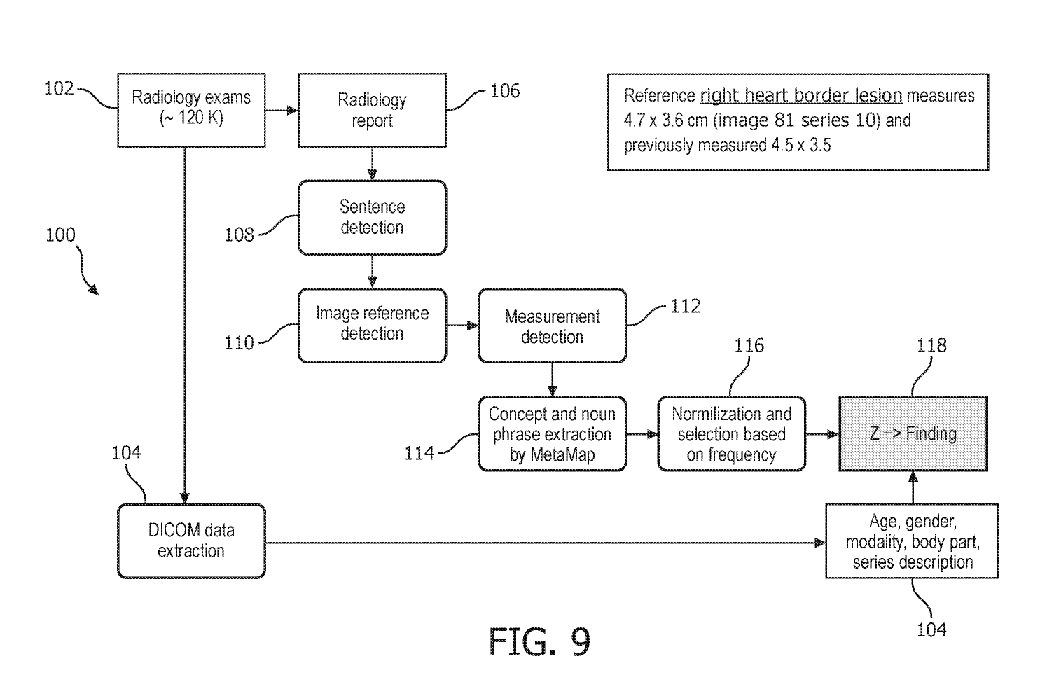

FIG. 9 illustrates a flowchart diagram of a method for generating a master finding list to provide a list of recommended annotations according to aspects of the present application.

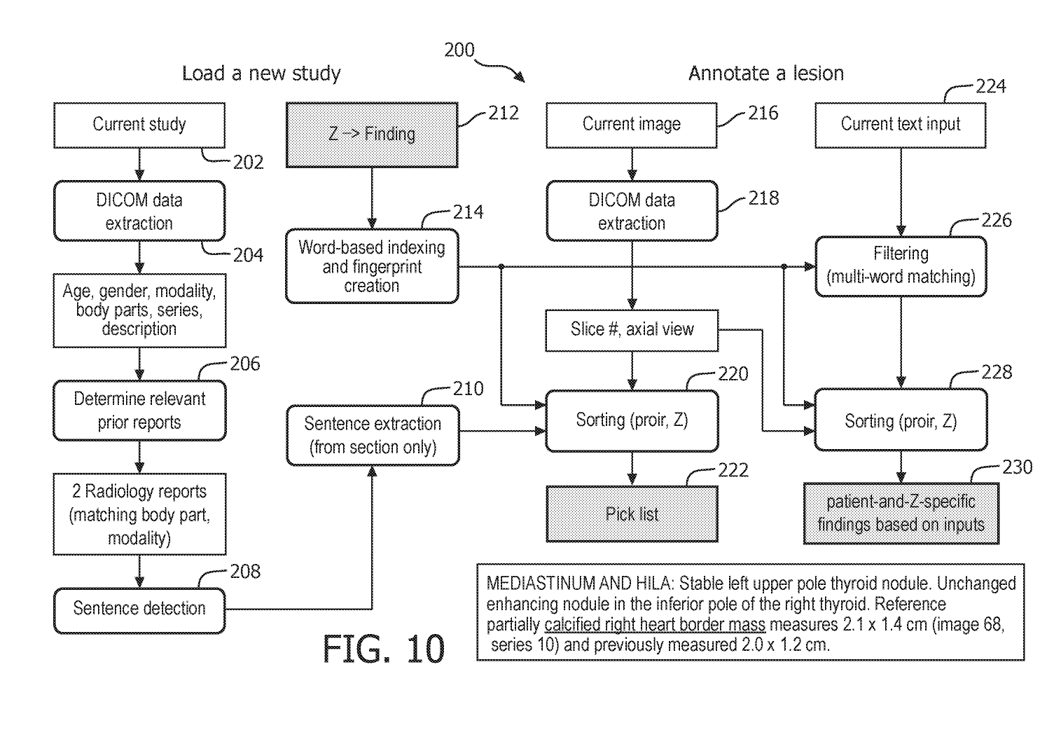

FIG. 10 illustrates a flowchart diagram of a method for determining relevant findings according to aspects of the present application.

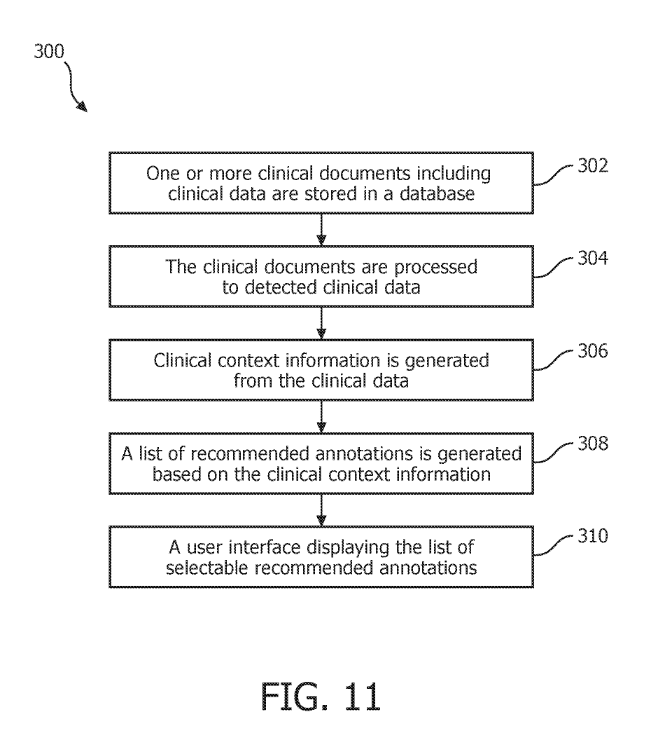

FIG. 11 illustrates a flowchart diagram of a method for providing recommended annotations according to aspects of the present application.

With reference to FIG. 1, a block diagram illustrates one embodiment of an IT infrastructure 10 of a medical institution, such as a hospital. The IT infrastructure 10 suitably includes a clinical information system 12, a clinical support system 14, a clinical interface system 16, and the like, interconnected via a communications network 20. It is contemplated that the communications network 20 includes one or more of the Internet, Intranet, a local area network, a wide area network, a wireless network, a wired network, a cellular network, a data bus, and the like. It should also be appreciated that the components of the IT infrastructure be located at a central location or at multiple remote locations.

The clinical information system 12 stores clinical documents including radiology reports, medical images, pathology reports, lab reports, lab/imaging reports, electronic health records, EMR data, and the like in a clinical information database 22. A clinical document may comprise documents with information relating to an entity, such as a patient. Some of the clinical documents may be free-text documents, whereas other documents may be structured document. Such a structured document may be a document which is generated by a computer program, based on data the user has provided by filling in an electronic form. For example, the structured document may be an XML document. Structured documents may comprise free-text portions. Such a free-text portion may be regarded as a free-text document encapsulated within a structured document. Consequently, free-text portions of structured documents may be treated by the system as free-text documents. Each of the clinical documents contains a list of information items. The list of information items including strings of free text, such as phases, sentences, paragraphs, words, and the like. The information items of the clinical documents can be generated automatically and/or manually. For example, various clinical systems automatically generate information items from previous clinical documents, dictation of speech, and the like. As to the latter, user input devices 24 can be employed. In some embodiments, the clinical information system 12 include display devices 26 providing users a user interface within which to manually enter the information items and/or for displaying clinical documents. In one embodiment, the clinical documents are stored locally in the clinical information database 22. In another embodiment, the clinical documents are stored nationally or regionally in the clinical information database 22. Examples of patient information systems include, but are not limited to, electronic medical record systems, departmental systems, and the like.

The clinical support system 14 utilizes natural language processing and pattern recognition to detect relevant finding-specific information within the clinical documents. The clinical support system 14 also generates clinical context information from the clinical documents including the most specific organ currently being observed by the user. Specifically, the clinical support system 14 continuously monitors the current image being observed from the user and relevant finding-specific information to determine the clinical context information. The clinical support system determines a list or set of possible annotation based on determined clinical context information. The clinical support system 14 further tracks the annotations associated with a given patient along with relevant meta-data (e.g., associated organ, type of annotation e.g., mass, action—e.g., “follow-up”.) The clinical support system 14 also generates a user interface that enables the user to easily annotate a region of interest, indicate the type of action for an annotation, enable a user to insert annotation related information directly into the report, and view a list of all prior annotations and navigate to the corresponding image if needed. The clinical support system 14 includes a display 44 such as a CRT display, a liquid crystal display, a light emitting diode display, to display the information items and user interface and a user input device 46 such as a keyboard and a mouse, for the clinician to input and/or modify the provided information items.

Specifically, the clinical support system 14 includes a natural language processing engine 30 which processes the clinical documents to detect information items in the clinical documents and to detect a pre-defined list of pertinent clinical findings and information. To accomplish this, the natural language processing engine 30 segments the clinical documents into information items including sections, paragraphs, sentences, words, and the like. Typically, clinical documents contain a time-stamped header with protocol information in addition to clinical history, techniques, comparison, findings, impression section headers, and the like. The content of sections can be easily detected using a predefined list of section headers and text matching techniques. Alternatively, third party software methods can be used, such as MedLEE. For example, if a list of pre-defined terms is given (“lung nodule”), string matching techniques can be used to detect if one of the terms is present in a given information item. The string matching techniques can be further enhanced to account for morphological and lexical variant (Lung nodule=lung nodules=lung nodule) and for terms that are spread over the information item (nodules in the lung=lung nodule). If the pre-defined list of terms contains ontology IDs, concept extraction methods can be used to extract concepts from a given information item. The IDs refer to concepts in a background ontology, such as SNOMED or RadLex. For concept extraction, third-party solutions can be leveraged, such as MetaMap. Further, natural language processing techniques are known in the art per se. It is possible to apply techniques such as template matching, and identification of instances of concepts, that are defined in ontologies, and relations between the instances of the concepts, to build a network of instances of semantic concepts and their relationships, as expressed by the free text.

The clinical support system 14 also includes a context extraction engine 32 that determines the most specific organ (or organs) being observed by the user to determine the clinical context information. For example, when a study is viewed in the clinical interface system 16, the DICOM header contains anatomical information including modality, body part, study/protocol description, series information, orientation (e.g., axial, sagittal, coronal) and window type (such as “lungs”, “liver”) which is utilized to determine the clinical context information. Standard image segmentation algorithms such as thresholding, k-means clustering, compression based methods, region-growing methods and partial differential equation-based methods also are utilized to determine the clinical context information. In one embodiment, the context extraction engine 32 utilizes algorithms to retrieve a list of anatomies for a given slice number and other metadata (e.g., patient age, gender, and study description). As an example, the context extraction engine 32 creates a lookup table that stores for a large number of patients the corresponding anatomy information for the patient parameters (e.g., age, gender) as well as study parameters. This table can then be used to estimate the organ from a slice number and possibly additional information such as patient age, gender, slice thickness and number of slices. More concretely, for instance, given slice 125, female gender and “CT Abdomen” study description, the algorithm would return a list of organs associated with this slice number (e.g., “liver”, “kidneys”, “spleen”). This information is then utilized by the context extraction engine 32 to generate the clinical context information.

The context extraction engine 32 also extracts clinical findings and information and the context of the extracted clinical findings and information to determine clinical context information. Specifically, the context extraction engine 32 extracts clinical findings and information from the clinical documents and generates clinical context information. To accomplish this, the context extraction engine 32 utilizes existing natural language processing algorithms like MedLEE or MetaMap to extract clinical findings and information. Additionally, the context extraction engine 32 can utilize user-defined rules to extract certain types of findings that may appear in the document. Further, the context extraction engine 32 can utilize the study type of the current study and the clinical pathway, which defines required clinical information to rule in/out diagnosis, to check the availability of the required clinical information in the present document. Further extensions of the context extraction engine 32 allow for deriving the context meta-data for a given piece of clinical information. For example, in one embodiment, the context extraction engine 32 derives the clinical nature of the information item. Background ontology, such as SNOMED and RadLex, can be used to determine if the information item is a diagnosis or symptom. Home-grown or third-party solutions (MetaMap) can be used to map an information item to ontology. The context extraction engine 32 utilizes this clinical findings and information to determine the clinical context information.

The clinical support system 14 also includes an annotation recommending engine 34 which utilizes the clinical context information to determine the most suitable (i.e., context sensitive) set of annotations. In one embodiment, the annotation recommending engine 34 creates and stores (e.g., via storing this information in a database) a list of study description-to-annotations mapping. For instance, this may contain a number of possible annotations related to modality=CT and bodypart =chest. For a study description CT CHEST, the context extraction engine 32 can determine the correct modality and bodypart, and use the mapping table to determine the suitable set of annotations. Further, a mapping table similar to the previous embodiment can be created by the annotation recommending engine 34 for the various anatomies that are extracted. This table can then be queried for a list of annotations for a given anatomy (e.g., liver). In another embodiment, the anatomy and the annotations can both be determined automatically. A large number of prior reports can be parsed using standard, natural language processing techniques to first identify the sentences containing the various anatomies (for instance, identified by the previous embodiment) and then parsing the sentences in which the anatomies are found for annotations. Alternatively, all sentences contained within relevant paragraph headers can be parsed to create the list of annotations belonging to that anatomy (e.g., all sentences under paragraph header “LIVER” will be liver related). This list can also be augmented/filtered by exploring other techniques such as co-occurrence of terms as well as using ontology/terminology mapping techniques to identify the annotations within the sentences (e.g., using MetaMap which is a state of the art engine to extract Unified Medical Language System concepts). This technique automatically creates the mapping table and a list of relevant annotations can be returned for a given anatomy. In another embodiment, RSNA report templates can be processed to determine findings common to organs. In yet another embodiment, the Reason for Exam of studies can be utilized. Terms related to clinical signs and symptoms and diagnosis are extracted using NLP and added to the lookup table. In this manner, suggestions on the findings related to an organ are be made/visualized based on slice number, modality, body-part, and clinical indications.

In another embodiment, the above mentioned techniques can be used on the clinical documents for a patient to determine the most suitable list of annotations for the patient for a given anatomy. The patient-specific annotations can be used to prioritize/sort the annotations list that is shown the user. In another embodiment, the annotation recommending engine 34 utilizes a sentence boundary and noun phrase detector. The clinical documents are narrative in nature and typically contain several institution-specific section headers such as Clinical Information to give a brief description of the reason for study, Comparison to refer to relevant prior studies, Findings to describe what has been observed in the images and Impression which contains diagnostic details and follow-up recommendations. Using natural language processing as a starting point, the annotation recommending engine 34 determines a sentence boundary detection algorithm that recognizes sections, paragraphs and sentences in narrative reports, as well as noun phrases within a sentence. In another embodiment, the annotation recommending engine 34 utilizes a master finding list to provide a list of recommended annotations. In this embodiment, the annotation recommending engine 34 parses the clinical documents to extract noun phrases from the Findings section to generate recommended annotations. The annotation recommending engine 34 utilizes keyword filter so that the noun phrases included at least one of the commonly used words such as “index” or “reference” since these are often used when describing findings. In a further embodiment, the annotation recommending engine 34 utilizes relevant prior reports to recommend annotations. Typically, radiologists refer to the most recent, relevant prior report to establish clinical context. The prior report usually contains information related to the patient's current status, especially about existing findings. Each report contains study information such as the modality (e.g., CT, MR) and the body part (e.g., head, chest) associated with the study. The annotations recommending engine 34 utilizes two relevant, distinct prior reports to establish context—first, the most recent prior report which has the same modality and body part; second, the most recent prior report having the same body part. Given a set of reports for a patient, the annotation recommending engine 34 determines the two relevant priors for a given study. In another embodiment, annotations are recommended utilizing a description sorter and filter. Given a set of finding descriptions, the sorting sorts the list using a specified set of rules. The annotation recommending engine 34 sorts the master finding list based on the sentences extracted from the prior reports. The annotation recommending engine 34 further filters the finding description list based on user input. In the simplest implementation, the annotation recommending engine 34 can utilize a simple string “contains” type operation for filtering. The matching can be restricted to match at the beginning of any word if needed. For instance, typing “h” would include “Right heart border lesion” as one of the matched candidates after filtering. Similarly, if needed, the use can also type multiple characters separated by a space to match multiple words in any order; for instance, “Right heart border lesion” will be a match for “h l”. In another embodiment, the annotations are recommended by displaying a list of candidate finding descriptions to the user in a real-time manner. When the user opens an imaging study, the annotation recommending engine 34 uses the DICOM header to determine the modality and body part information. The reports are then parsed using the sentence detection engine to extract sentences from the Findings section. The master finding list is then sorted using the sorting engine and displayed to the user. The list is filtered using the user input if needed.

The clinical support system 14 also includes an annotation tracking engine 36 which tracks all annotations for a patient along with relevant meta-data. Meta-data includes items such as associated organ, type of annotation (e.g., mass), action/recommendation (e.g., “follow-up”). This engine stores all annotations for a patient. Each time a new annotation is created, a representation is stored in the module. Information in this module is subsequently used by the graphical user interface for user-friendly rendering.

The clinical support system 14 also includes a clinical interface engine 38 which generates a user interface that enables the user to easily annotate a region of interest, indicate the type of action for an annotation, enable a user to insert annotation related information directly into the report, and view a list of all prior annotations and navigate to the corresponding image if needed. For example, when a user opens a study, the clinical interface engine 38 provides the user a context-sensitive (as determined by the context extraction module) list of annotations. The trigger to display the annotations can include the user right-clicking on a specific slice and selecting from a context menu a suitable annotation. As shown in FIG. 2, if a specific organ cannot be determined, the system will show a context-sensitive list of organs based on current slice and the user can select the most appropriate organ and then the annotation. If a specific organ can be determined, the organ-specific list of annotations will be shown to the user. In another embodiment, a pop-up based user interface where the user can select from a context-sensitive list of annotations by selecting a suitable combination of multiple terms is utilized. For instance, FIG. 3 shows a list of adrenal-specific annotations that have been identified and displayed to the user. In this instance, the user has selected a combination of options to indicate that there are “calcified lesions in the left and right adrenal glands”. The list of suggested annotations would differ per anatomy. In another embodiment, the recommended annotations are provided by the user moving the mouse inside an area identified by image segmentation algorithms and indicating the desire to annotation (e.g., by double clicking on the region of interest on the image). In yet a further embodiment, the clinical interface engine 38 utilizes eye-tracking type technologies to detect the eye-movement and use other sensory information (e.g., fixation, dwell time) to determine the region of interest and provide recommended annotations. It should also be contemplated that the user interface enable the user to annotate various types of clinical documents.

The clinical interface engine 38 also enables the user to annotate a clinical document using an annotation that is marked as actionable. An annotation is actionable if its content is structured or is readily structured with elementary mapping methods and if the structure has a pre-defined semantic connotation. In this manner, an annotation could indicate that “this lesion needs to be biopsied”. The annotation could subsequently be picked up by a biopsy management system that then creates a biopsy entry that is linked to the exam and image on which the annotation was made. For instance, FIG. 4 shows how the image has been annotated indicating that this is important as a “Teaching file”. Similarly, the user interface shown in FIG. 3 can be augmented to capture the actionable information as well. For instance, FIG. 5 indicates how the “calcified lesions observed in the left and right adrenal glands” need to be “monitored” and also be used as a “teaching file”. The user interface shown in FIG. 6 can be refined further by using the algorithms where only a patient-specific list of annotations is shown to the user based on patient history. The user can also select a prior annotation (e.g., from a drop-down list) that will automatically populate the associated meta-data. Alternatively, the user can click on the relevant options or type this information. In another embodiment, the user interface also supports inserting the annotations into the radiology report. In a first implementation, this may include a menu item that allows the user to copy a free-text rendering of all annotations into the “Microsoft Clipboard”. From there the annotation rendering can be readily pasted into the report. In another embodiment, the user interface also supports user-friendly rendering of the annotations that are maintained in the “annotation tracker” module. For instance, one implementation may look as that shown in FIG. 7. In this instance, the annotation dates are shown in the columns while the annotation type is shown in each row. The interface can be further enhanced to support different types of rendering (e.g., grouped by anatomy instead of annotation type), as well as filtering. Annotation text is hyperlinked to the corresponding image slice so that clicking on it would automatically open the image containing the annotation (by opening the associated study and setting focus to the relevant image). In another embodiment, as shown in FIG. 8, the recommended annotations are provided based on the characters typed by the users. For example, by typing in the typing in the character “r” the interface would display “Right heart border lesion as the most ideal annotation based on the clinical context.

The clinical interface system 16 displays the user interface that enables the user to easily annotate a region of interest, indicate the type of action for an annotation, enable a user to insert annotation related information directly into the report, and view a list of all prior annotations and navigate to the corresponding image if needed.. The clinical interface system 16 receives the user interface and displays the view to the caregiver on a display 48. The clinical interface system 16 also includes a user input device 50 such as a touch screen or keyboard and a mouse, for the clinician to input and/or modify the user interface views. Examples of caregiver interface system include, but are not limited to, personal data assistant (PDA), cellular smartphones, personal computers, or the like.

The components of the IT infrastructure 10 suitably include processors 60 executing computer executable instructions embodying the foregoing functionality, where the computer executable instructions are stored on memories 62 associated with the processors 60. It is, however, contemplated that at least some of the foregoing functionality can be implemented in hardware without the use of processors. For example, analog circuitry can be employed. Further, the components of the IT infrastructure 10 include communication units 64 providing the processors 60 an interface from which to communicate over the communications network 20. Even more, although the foregoing components of the IT infrastructure 10 were discretely described, it is to be appreciated that the components can be combined.

With reference to FIG. 9, a flowchart diagram 100 of a method for generating a master finding list to provide a list of recommended annotations is illustrated. In a step 102, a plurality of radiology exams are retrieved. In a step 104, the DICOM data is extracted from the plurality of radiology exams. In a step 106, information is extracted from the DICOM data. In a step 108, the radiology reports are extracted from the plurality of radiology exams. In a step 110, sentence detection is utilized on the radiology reports. In a step 112, measurement detection is utilized on the radiology reports. In a step 114, concept and name phrase extraction is utilized on the radiology reports. In a step 116, normalization and selection based on frequency is performed on the radiology reports. In a step 118, finding master list is determined.

With reference to FIG. 10, a flowchart diagram 200 of a method for determining relevant findings is illustrated. To load a new study, a current study is retrieved in a step 202. In a step 204, DICOM data is extracted from the study. In a step 206, relevant prior reports are determined based on the DICOM data. In a step 208, sentence detection is utilized on the relevant prior reports. In a step 210, sentence extraction is performed on the finding section of the relevant prior reports. A master finding list is retrieved in a step 212. In a step 214, word-based indexing and fingerprint creation is preformed based on the master finding list. To annotate a lesion, a current image is retrieved in a step 216. In a step 218, DICOM data from the current image is extracted. In a step 220, annotations are sorted based on the sentence extraction and word-based indexing and fingerprint creation. In a step 222, a list of recommended annotation is provided. In a step 224, current text is input by the user. In a step 226, filtering is performed utilizing the word-based indexing and fingerprint creation. In a step 228, sorting is performed utilizing the DICOM data, filtering, and word-based indexing and fingerprint creation. In a step 230, patient specific findings based on the inputs are provided.

With reference to FIG. 11, a flowchart diagram 300 of a method for determining relevant findings is illustrated. In a step 302, one or more clinical documents including clinical data are stored in a database. In a step 304, the clinical documents are processed to detected clinical data. In a step 306, clinical context information is generated from the clinical data. In a step 308, a list of recommended annotations is generated based on the clinical context information. In a step 310, a user interface displaying the list of selectable recommended annotations.

As used herein, a memory includes one or more of a non-transient computer readable medium; a magnetic disk or other magnetic storage medium; an optical disk or other optical storage medium; a random access memory (RAM), read-only memory (ROM), or other electronic memory device or chip or set of operatively interconnected chips; an Internet/Intranet server from which the stored instructions may be retrieved via the Internet/Intranet or a local area network; or so forth. Further, as used herein, a processor includes one or more of a microprocessor, a microcontroller, a graphic processing unit (GPU), an application-specific integrated circuit (ASIC), a field-programmable gate array (FPGA), personal data assistant (PDA), cellular smartphones, mobile watches, computing glass, and similar body worn, implanted or carried mobile gear; a user input device includes one or more of a mouse, a keyboard, a touch screen display, one or more buttons, one or more switches, one or more toggles, and the like; and a display device includes one or more of a LCD display, an LED display, a plasma display, a projection display, a touch screen display, and the like.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A system for providing actionable annotations, the system comprising:
a clinical database storing one or more clinical documents including clinical data;
a natural language processing engine which processes the clinical documents to detected clinical data;
a context extraction and classification engine which generates clinical context information from the clinical data;
an annotation recommending engine which generates a list of recommended actionable annotations based on the clinical context information; and
a clinical interface engine which generates a user interface displaying the list of selectable recommended annotations.

2. The system according to claim 1, wherein the context extraction and classification engine generates clinical context information based on an image being displayed to the user.

3. The system according to claim 1, further including:
an annotation tracker which tracks all annotations for a patient along with relevant meta data.

4. The system according to claim 1, wherein user interface includes a menu based interface which enables the user to select various combinations of annotations.

5. The system according to claim 1, wherein the actionable annotation is actionable in that its content is structured or readily structured with elementary mapping methods and in that the structure has a pre-defined semantic annotation.

6. (canceled)

7. The system according to claim 1, wherein user interface enables the user to insert the selected annotations into a radiology report.

8. (canceled)

9. (canceled)

10. (canceled)

11. (canceled)

12. (canceled)

13. A method for providing recommended actionable annotations, the method comprising:
storing one or more clinical documents including clinical data;
processing the clinical documents to detected clinical data;
generating clinical context information from the clinical data;
generating a list of recommended actionable annotations based on the clinical context information; and
generating a user interface displaying the list of selectable recommended annotations.

14. The method according to claim 13, further including:
generate clinical context information based on an image being displayed to the user.

15. The method according to claim 13, further including:
track all annotations for a patient along with relevant meta data.

16. The method according to claim 13, wherein user interface includes a menu based interface which enables the user to select various combinations of annotations.

17. (canceled)
